(19) United States
(12) Patent Application Publication
(10) Pub. No.: US 2002/0065944 A1
(43) Pub. Date: May 30, 2002

(54) Enhancement of communication capabilities

(76) Inventors: Marianne Hickey, Bristol (GB); Michael Christoper McTernan, Lancashire (GB)

Correspondence Address: LOWE HAUPTMAN GOPSTEIN, GILMAN AND BERNER LLP, SUITE 310, 1700 DIAGONAL ROAD, ALEXANDRIA, VA, 22314

(21) Appl. No.: 09/994,915

(22) Filed: Nov. 27, 2001

(30) Foreign Application Priority Data
Nov. 29, 2000 (GB) 0029025.4

(51) Int. Cl. G06F 9/00

(52) U.S. Cl. 709/310

(57) ABSTRACT

A method is provided of enhancing communication between a user using a first device such as a cell phone, and a content server with which the user is interacting through a multimodal browser. The communication is managed as a session having one or more participants, the user being an initial participant to the session. The user, using the first device, passes on session joining information to a second device, for example a printer or display, and the second device uses the joining information to join the session. The multimodal browser then distributes content, including content references, from the content server to the devices in the session according to their capabilities.

### FIELD OF THE INVENTION

The present invention relates to the enhancement of communication capabilities in an adhoc manner between a user using a first device and an content server with which the user is interacting through an interfacing handler. In particular, but not exclusively, the present invention relates to the inclusion of selected peripheral devices into a voice browser session.

### BACKGROUND OF THE INVENTION

In recent years there has been an explosion in the number of services available over the World Wide Web on the public internet (generally referred to as the “web”), the web being composed of a myriad of pages linked together by hyperlinks and delivered by servers on request using the HTTP protocol. Each page comprises content marked up with tags to enable the receiving application (typically a GUI browser) to render the page content in the manner intended by the page author; the markup language used for standard web pages is HTML (HyperText Markup Language).

However, today far more people have access to a telephone than have access to a computer with an Internet connection. Sales of cellphones are outstripping PC sales so that many people have already or soon will have a phone within reach where ever they go. As a result, there is increasing interest in being able to access web-based services from phones. ‘Voice Browsers’ offer the promise of allowing everyone to access web-based services from any phone, making it practical to access the Web any time and any where, whether at home, on the move, or at work.

Voice browsers allow people to access the Web using speech synthesis, pre-recorded audio, and speech recognition. FIG. 1 of the accompanying drawings illustrates the general role played by a voice browser. As can be seen, a voice browser is interposed between a user 2 and a voice page server 4. This server 4 holds voice service pages (text pages) that are marked-up with tags of a voice-related markup language (or languages).

When a page is requested by the user 2, it is interpreted at a top level (dialog level) by a dialog manager 7 of the voice browser 3 and output intended for the user is passed in text form to a Text-To-Speech (TTS) converter 6 which provides appropriate voice output to the user. User voice input is converted to text by speech recognition module 5 of the voice browser 3 and the dialog manager 7 determines what action is to be taken according to the received input and the directions in the original page. The voice input / output interface can be supplemented by keypads and small displays.

In general terms, therefore, a voice browser can be considered as a largely software device which interprets a voice markup language and generate a dialog with voice output, and possibly other output modalities, and / or voice input, and possibly other modalities (this definition derives from a working draft, dated September 2000, of the Voice browser Working Group of the World Wide Web Consortium).

Voice browsers may also be used together with graphical displays, keyboards, and pointing devices (e.g. a mouse) in order to produce a rich “multimodal voice browser”. Voice interfaces and the keyboard, pointing device and display maybe used as alternate interfaces to the same service or could be seen as being used together to give a rich interface using all these modes combined.

Some examples of devices that allow multimodal interactions could be multimedia PC, or a communication appliance incorporating a display, keyboard, microphone and speaker/headset, an in car Voice Browser might have display and speech interfaces that could work together, or a Kiosk.

Some services may use all the modes together to provide an enhanced user experience, for example, a user could touch a street map displayed on a touch sensitive display and say “Tell me how I get here?”. Some services might offer alternate interfaces allowing the user flexibility when doing different activities. For example while driving speech could be used to access services, but a passenger might used the keyboard.

FIG. 2 of the accompanying drawings shows in greater detail the components of an example voice browser for handling voice pages 15 marked up with tags related to four different voice markup languages, namely:

tags of a dialog markup language that serves to specify voice dialog behaviour;

tags of a multimodal markup language that extends the dialog markup language to support other input modes (keyboard, mouse, etc.) and output modes (large and small screens);

tags of a speech grammar markup language that serve to specify the grammar of user input; and

tags of a speech synthesis markup language that serve to specify voice characteristics, types of sentences, word emphasis, etc.

When a page 15 is loaded into the voice browser, dialog manager 7 determines from the dialog tags and multimodal tags what actions are to be taken (the dialog manager being programmed to understand both the dialog and multimodal languages 19). These actions may include auxiliary functions 18 (available at any time during page processing) accessible through APIs and including such things as database lookups, user identity and validation, telephone call control etc. When speech output to the user is called for, the semantics of the output is passed, with any associated speech synthesis tags, to output channel 12 where a language generator 23 produces the final text to be rendered into speech by text-to-speech converter 6 and output to speaker 17. In the simplest case, the text to be rendered into speech is fully specified in the voice page 15 and the language generator 23 is not required for generating the final output text; however, in more complex cases, only semantic elements are passed, embedded in tags of a natural language semantics markup language (not depicted in FIG. 2) that is understood by the language generator. The TTS converter 6 takes account of the speech synthesis tags when effecting text to speech conversion for which purpose it is cognisant of the speech synthesis markup language 25.

User voice input is received by microphone 16 and supplied to an input channel of the voice browser. Speech recogniser 5 generates text which is fed to a language understanding module 21 to produce semantics of the input for passing to the dialog manager 7. The speech recogniser 5 and language understanding module 21 work according to specific lexicon and grammar markup language 22 and, of course, take account of any grammar tags related to the current input that appear in page 15. The semantic output to the dialog manager 7 may simply be a permitted input word or may be more complex and include embedded tags of a natural language semantics markup language. The dialog manager 7 determines what action to take next (including, for example, fetching another page) based on the received user input and the dialog tags in the current page 15.

Any multimodal tags in the voice page 15 are used to control and interpret multimodal input/output. Such input/output is enabled by an appropriate recogniser 27 in the input channel 11 and an appropriate output constructor 28 in the output channel 12.

Whatever its precise form, the voice browser can be located at any point between the user and the voice page server. FIGS. 3 to 5 illustrate three possibilities in the case where the voice browser functionality is kept all together; many other possibilities exist when the functional components of the voice browser are separated and located in different logical/physical locations.

In FIG. 3, the voice browser 3 is depicted as incorporated into an end-user system 8 (such as a PC or mobile entity) associated with user 2. In this case, the voice page server 4 is connected to the voice browser 3 by any suitable data-capable bearer service extending across one or more networks 9 that serve to provide connectivity between server 4 and end-user system 8. The data-capable bearer service is only required to carry text-based pages and therefore does not require a high bandwidth.

FIG. 4 shows the voice browser 3 as co-located with the voice page server 4. In this case, voice input/output is passed across a voice network 9 between the end-user system 8 and the voice browser 3 at the voice page server site. The fact that the voice service is embodied as voice pages interpreted by a voice browser is not apparent to the user or network and the service could be implemented in other ways without the user or network being aware.

In FIG. 5, the voice browser 3 is located in the network infrastructure between the enduser system 8 and the voice page server 4, voice input and output passing between the enduser system and voice browser over one network leg, and voice-page text data passing between the voice page server 4 and voice browser 3 over another network leg. This arrangement has certain advantages; in particular, by locating expensive resources (speech recognition, TTS converter) in the network, they can be used for many different users with user profiles being used to customise the voice-browser service provided to each user.

A more specific and detailed example will now be given to illustrate how voice browser functionality can be differently located between the user and server. More particularly, FIG. 6 illustrates the provision of voice services to a mobile entity 40 which can communicate over a mobile communication infrastructure with voice-based service systems 4, 61. In this example, the mobile entity 40 communicates, using radio subsystem 42 and a phone subsystem 43, with the fixed infrastructure of a GSM PLMN (Public Land Mobile Network) 30 to provide basic voice telephony services. In addition, the mobile entity 40 includes a data-handling subsystem 45 interworking, via data interface 44, with the radio subsystem 42 for the transmission and reception of data over a data-capable bearer service provided by the PLMN; the data-capable bearer service enables the mobile entity 40 to access the public Internet 60 (or other data network). The data handling subsystem 45 supports an operating environment 46 in which applications run, the operating environment including an appropriate communications stack.

Considering the FIG. 6 arrangement in more detail, the fixed infrastructure 30 of the GSM PLMN comprises one or more Base Station Subsystems (BSS) 31 and a Network and Switching Subsystem NSS 32. Each BSS 31 comprises a Base Station Controller (BSC) 34 controlling multiple Base Transceiver Stations (BTS) 33 each associated with a respective “cell” of the radio network. When active, the radio subsystem 42 of the mobile entity 20 communicates via a radio link with the BTS 33 of the cell in which the mobile entity is currently located. As regards the NSS 32, this comprises one or more Mobile Switching Centers (MSC) 35 together with other elements such as Visitor Location Registers 52 and Home Location Register 52.

When the mobile entity 40 is used to make a normal telephone call, a traffic circuit for carrying digitised voice is set up through the relevant BSS 31 to the NSS 32 which is then responsible for routing the call to the target phone whether in the same PLMN or in another network such as PSTN (Public Switched Telephone Network) 56.

With respect to data transmission to/from the mobile entity 40, in the present example three different data-capable bearer services are depicted though other possibilities exist. A first data-capable bearer service is available in the form of a Circuit Switched Data (CSD) service; in this case a full traffic circuit is used for carrying data and the MSC 35 routes the circuit to an InterWorking Function DVF 54 the precise nature of which depends on what is connected to the other side of the IWF. Thus, IWF could be configured to provide direct access to the public Internet 60 (that is, provide functionality similar to an IAP—Internet Access Provider IAP). Alternatively, the IWF could simply be a modem connecting to PSTN 56; in this case, Internet access can be achieved by connection across the PSTN to a standard IAP.

A second, low bandwidth, data-capable bearer service is available through use of the Short Message Service that passes data carried in signalling channel slots to an SMS unit 53 which can be arranged to provide connectivity to the public Internet 60.

A third data-capable bearer service is provided in the form of GPRS (General Packet Radio Service which enables IP (or X.25) packet data to be passed from the data handling system of the mobile entity 40, via the data interface 44, radio subsystem 41 and relevant BSS 31, to a GPRS network 37 of the PLMN 30 (and vice versa). The GPRS network 37 includes a SGSN (Serving GPRS Support Node) 38 interfacing BSC 34 with the network 37, and a GGSN (Gateway GPRS Support Node) interfacing the network 37 with an external network (in this example, the public Internet 60). Full details of GPRS can be found in the ETSI (European Telecommunications Standards Institute) GSM 03.60 specification. Using GPRS, the mobile entity 40 can exchange packet data via the BSS 31 and GPRS network 37 with entities connected to the public Internet 60.

The data connection between the PLMN 30 and the Internet 60 will generally be through a gateway 55 providing functionality such as firewall and proxy functionality.

Different data-capable bearer services to those described above may be provided, the described services being simply examples of what is possible. Indeed, whilst the above description of the connectivity of a mobile entity to resources connected to the communications infrastructure, has been given with reference to a PLMN based on GSM technology, it will be appreciated that many other cellular radio technologies exist (for example, UTMS, CDMA etc.) and can typically provide equivalent functionality to that described for the GSM PLMN 30.

The mobile entity 40tself may take many different forms. For example, it could be two separate units such as a mobile phone (providing elements 42-44) and a mobile PC (providing the data-handling system 45), coupled by an appropriate link (wireline, infrared or even short range radio system such as Bluetooth). Alternatively, mobile entity 40 could be a single unit.

FIG. 6 depicts both a voice page server 4 connected to the public internet 60 and a voice-based service system 61 accessible via the normal telephone links.

The voice-based service system 61 is, for example, a call center and would typically be connected to the PSTN 56 and be accessible to mobile entity 40 via PLMN 30 and PSTN 56. The system 56 could also (or alternatively) be connected directly to the PLMN though this is unlikely. The voice-based service system 61 includes interactive voice response units implemented using voice pages interpreted by a voice browser 3A. Thus a user can user mobile entity 40 to talk to the service system 61 over the voice circuits of the telephone infrastructure; this arrangement corresponds to the situation illustrated in FIG. 4 where the voice browser is co-located with the voice page server.

If, as shown, the service system 61 is also connected to the public internet 60 and is enabled to receive VoIP (Voice over IP) telephone traffic, then provided the data handling subsystem 45 of the mobile entity 40 has VoIP functionality, the user could use a data capable bearer service of the PLMN 30 of sufficient bandwidth and QoS (quality of service) to establish a VoIP call, via PLMN 30, gateway 55, and internet 60, with the service system 61.

With regard to access to the voice services embodied in the voice pages held by voice page server 4 connected to the public internet 60, if the data-handling subsystem of the mobile entity is equipped with a voice browser 3E, then all that the mobile entity need do to use these services is to establish a data-capable bearer connection with the voice page server 4 via the PLMN 30, gateway 55 and internet 60, this connection then being used to carry the text based request response messages between the server 61 and mobile entity 4. This corresponds to the arrangement depicted in FIG. 3.

PSTN 56 can be provisioned with a voice browser 3B at internet gateway 57 access point. This enables the mobile entity to place a voice call to a number that routes the call to the voice browser and then has the latter connect to the voice page server 4 to retrieve particular voice pages. Voice browser then interprets these pages back to the mobile entity over the voice circuits of the telephone network. In a similar manner, PLMN 30 could also be provided with a voice browser at its internet gateway 55. Again, third party service providers could provide voice browser services 3D accessible over the public telephone network and connected to the internet to connect with server 4. All these arrangements are embodiments of the situation depicted in FIG. 5 where the voice browser is located in the communication network infrastructure between the user end system and voice page server.

It will be appreciated that whilst the foregoing description given with respect to FIG. 6 concerns the use of voice browsers in a cellular mobile network environment, voice browsers are equally applicable to other environments with mobile or static connectivity to the user.

Voice-based services are highly attractive because of their ease of use and the ready availability of mobile phones as an interface; however, a voice-only interface lacks the richness possible with multiple media types.

It is an object of the present invention to provide a method and apparatus by which users can enhance their voice browsing experience to cover other media types in an adhoc manner.

### SUMMARY OF THE INVENTION

According to one aspect of the present invention, there is provided a method of enhancing communication between a user using a first device and a content server with which the user is interacting through an interfacing handler, wherein:

the communication is managed as a session having one or more participants with the user, via the first device, being an initial participant to the session;

the user, using the first device, passes on session joining information to at least one second device;

the at least one second device uses the joining information to join the session; and

the interfacing handler sends content and/or content references to the participants in the session.

According to another aspect of the present invention, there is provided a voice browser service system for providing voice-form content to a user device, the service system comprising:

a session manager operative to set up a communication session with the user device as an initial member, and to pass the user device a session identifier for the session;

means for retrieving content from a content server and delivering at least some of that content as voice signals to the user device;

receiving means for receiving, from a further device, a joining request including said session identifier and capability information concerning what types of content the further device can handle, the receiving means being operative to pass the request to the session manager, and the session manager being responsive to the request to join the said further device to the communication session and register its capability information; and

means for sending to said further device, whilst joined to the communication session, elements of the said content retrieved from the content server that are of a type which, according to the device's registered capability information, the further device can handle.

According to a further aspect of the present invention, there is provided a user communication device comprising:

means for setting up a communications session with an interfacing handler through which the user device can receive content from a content server;

means for assembling session joining data for enabling a further device to join the communication session by that device passing the session joining data to the interfacing handler; and

means for sending the session joining information to a said further device independently of the interfacing handler.

According to a still further aspect of the present invention, there is provided a peripheral device comprising:

peripheral functionality;

a short-range communications subsystem for receiving session joining data over a short-range communications link; and

a communications subsystem for sending the session joining information to an interfacing handler to join an existing communication session and to receive content for output via the peripheral functionality of the device.

### BRIEF DESCRIPTION OF THE DRAWINGS

A method and apparatus embodying the invention will now be described, by way of non-limiting example, with reference to the accompanying diagrammatic drawings, in which:

FIG. 1 is a diagram illustrating the role of a voice browser;

FIG. 2 is a diagram showing the functional elements of a voice browser and their relationship to different types of voice markup tags;

FIG. 3 is a diagram showing a voice service implemented with voice browser functionality located in an end-user system;

FIG. 4 is a diagram showing a voice service implemented with voice browser functionality co-located with a voice page server;

FIG. 5 is a diagram showing a voice service implemented with voice browser functionality located in a network between the end-user system and voice page server;

FIG. 6 is a diagram of a mobile entity accessing voice services via various routes through a communications infrastructure including a PLMN, PSTN and public internet; and

FIG. 7 is a diagram of an embodiment of the invention involving a mobile phone for accessing a remote voice page server serving multimodal pages.

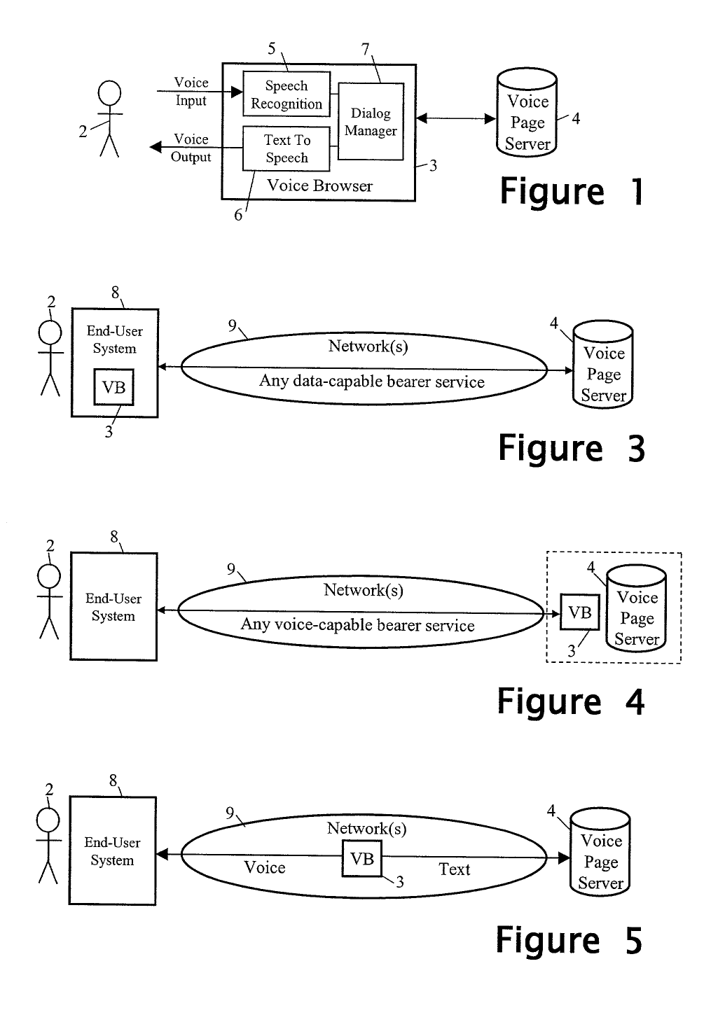

### BEST MODE FOR CARRYING OUT THE INVENTION

In the following description, voice services are described based on voice page servers serving multimodal pages with embedded markup tags to voice browsers with multimodal capabilities. Unless otherwise indicated, the foregoing description of voice browsers with multimodal capabilities, and their possible locations and access methods is to be taken as applying also to the described embodiments of the invention. Furthermore, although browser based forms of voice services are preferred, the present invention in its widest conception, is not limited to these forms of voice service system and other suitable systems will be apparent to persons skilled in the art.

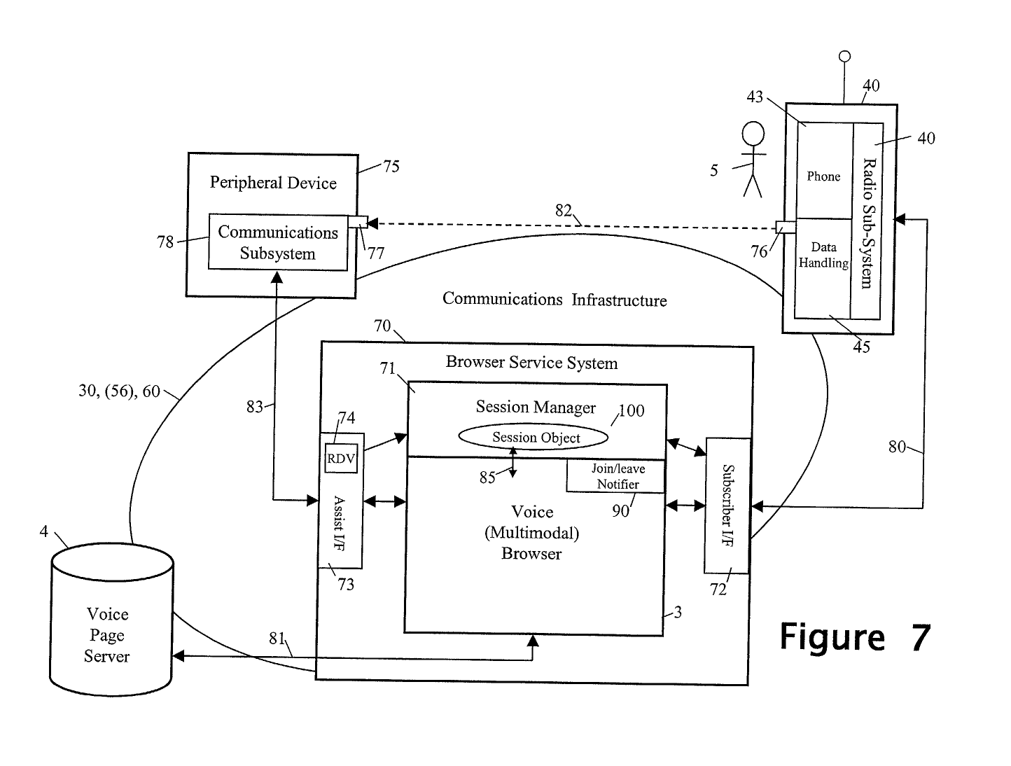

In the embodiment of the invention shown in FIG. 7, user 5 is using mobile device 40 to browse content server 4 that hosts voice pages with multimodal markup as well as files of various media types that are referenced by the multimodal-tagged voice pages. The user is interfacing with the content server 4 through a voice browser 3 that is hosted in a browser service system 70 connected to the communications infrastructure (here comprising PLMN 30, internet 60 and, potentially, PSTN 56); the service system 70 may be provided by a network operator or a third party. The content server 4 thus exchanges content data with the browser 3 (see arrow 81) and the user exchanges voice data with the browser 3 (see arrow 80).

User 5 is a registered subscriber to the voice browser service of system 70 and can connect up to the voice browser service whenever the user wishes by connecting to a subscriber interface 72 of the service system and supplying a username and password. Connection between the mobile device 40 and voice browser 3 can be either over a voice circuit or a data connection as already described in the introduction to the present specification.

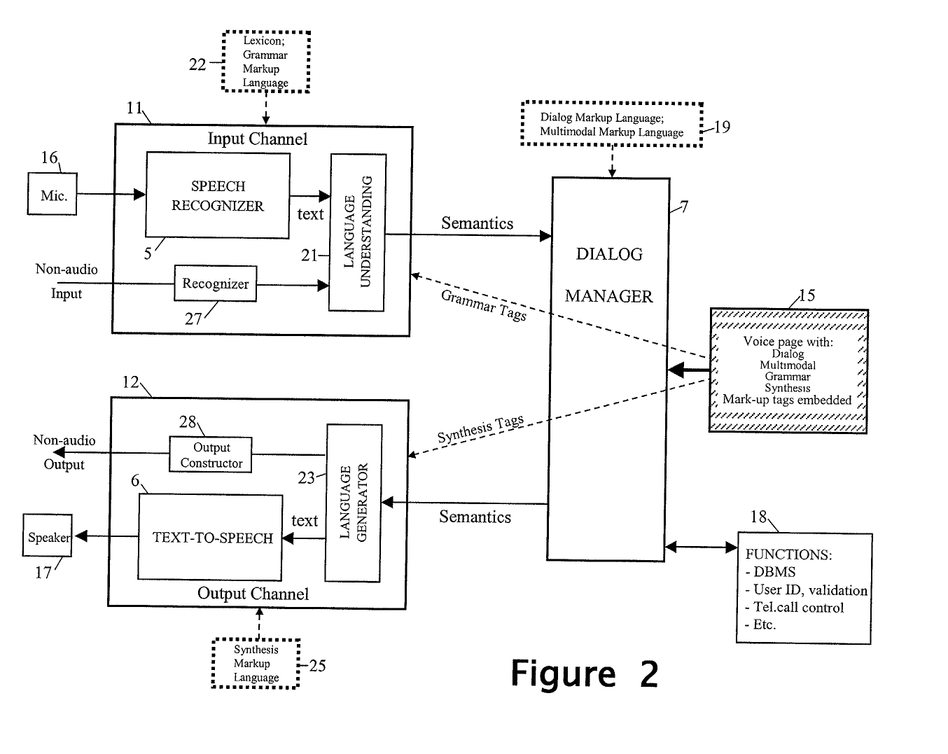

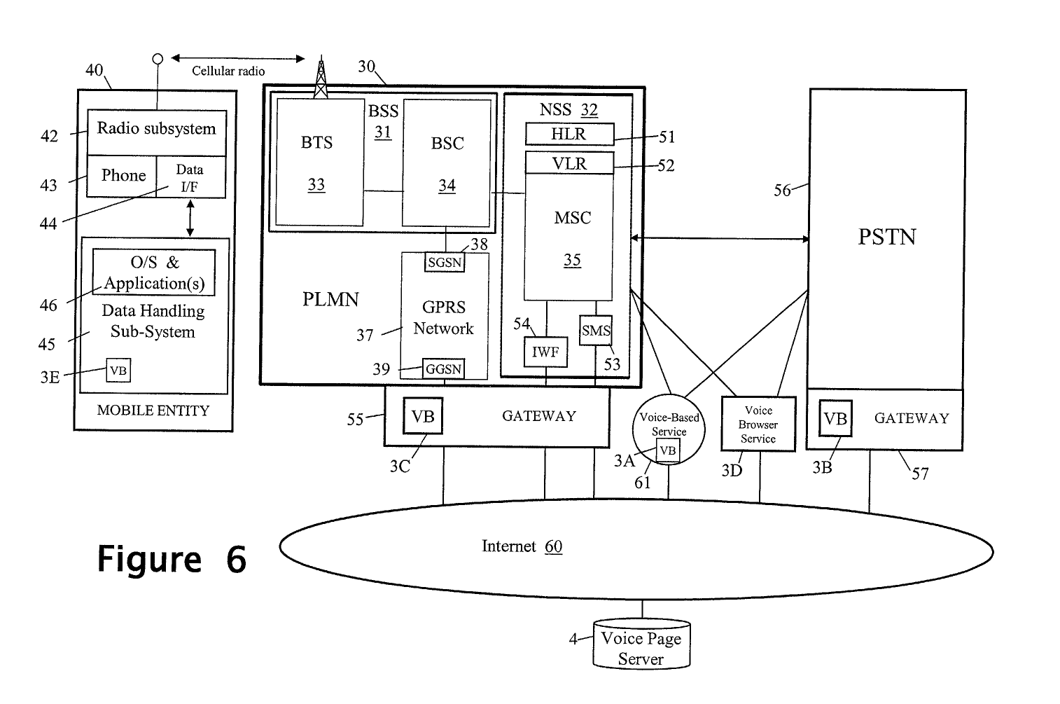

The voice browser 3 has a multimodal capability as described above with reference to FIG. 2.

The service system includes a session manager 71 which whenever a subscriber logs on their voice browser service, generates a new session object instance 100 for the communication session with the user. The session object 100 holds data about the communication session including the current participants to the session and the content server currently visited. Initially, the sole participant is the subscriber (user 5). The session object 100 also records the media-handling capabilities of each participant device. In the present example, it is assumed that the mobile entity 40 only has a voice (phone) interface with the user, and so the user's device 40 is only ascribed this capability in the session object. The capability information can be passed to the service system at the time a device connects to the system using an appropriate protocol (or, for the user's device, can be stored at the system 70).

The user uses voice browser 3 to browse the server 4 in normal manner. However, the user is told that there is an interesting video clip on a topic of interest—of course, solely with the voice capability of the device 40, the user is unable to see this video. The user therefore instructs a nearby video output device (peripheral 75) to join the user's current session with the service system. This is achieved by the sending of joining information over a short-range communication link 82 from the device 40 to the device 75. This short-range link can be, for example, a Bluetooth radio link or an infrared link with the devices 40 and 75 having transmitter 76 and receiver 77 respectively. The joining information comprises an address (e.g. URL) of an “assist” interface 73 of the service system and session-identifying information; this latter can simply be a user identifier but is preferably a session-specific identifier that is randomly created for each session and passed to the user as part of the log-in process.

A communications subsystem 78 of the peripheral device 75 uses the joining information to connect with the assist interface 73 of the service system 70 (see arrow 83) and pass the session-identifying information to a rendezvous (RDV) manager 74. The manager 74 searches the current session objects held by session manager to find which session the device 75 is wishing to join and when the correct session object 100 is found, joins the device to the session by storing its communication capabilities and connect data in the session object. At the same time, the user is notified by a notification unit 90 of the browser 3 that the device 75 has joined the session.

The browser has access to the session object 100 and therefore knows what devices are connected to the session and what media capabilities they posses. Thus, upon the user asking to see the video clip of interest, the browser knows from checking session object 100 that device 75 is a video display device capable of receiving a video clip. The browser can interact with the device in several ways. Firstly, the browser can send messages for display, these messages being generally content from the server 4 that have been marked up as for visual output. Secondly, the browser can receive a video file and interpret it for sending on to the device 75 for display. Thirdly, the browser 75 can simply pass the device all references to video files, the device 75 then being responsible for fetching and displaying the referenced file. In the present case, either the second or third possibilities are used to display the video clip.

If now the user wishes to print out an image or text article, the use can join in a printer device to the session and tell the browser to print the required item. Again, the browser looks in session object 100 to ascertain which participant device is capable of performing this operation before sending the desired content for printing.

Device to be joined into the session are not limited to local devices since the mobile device can be used to send the required joining information to remote devices, out of range of the short-range transmitter 76.

Many variants are, of course, possible to the arrangement described above with reference to FIG. 7. For example, whilst in the foregoing description the inclusion of additional devices into a session has been done to enhance a voice browsing experience, the basic session could have been established around browsing in different modalities, such as with a normal visual browser. In this latter case, one of the devices included into the session on an adhoc basis could be a phone or other device supporting voice communication.

Furthermore, it will be appreciated that it is not necessary for the browser service system 70 to be provided with a separate assist interface 73 through which devices such as peripheral device 75 connect to the system 70; instead, the interface 72 can serve both the role of subscriber interface and assist interface, the messages from the user device and peripheral device being arranged to distinguish the role of each device.

The session manager 71 could be associated with the server 4 rather than with the browser service system. In this case, each user visiting the site is treated like a subscriber in the FIG. 7 embodiment and can pass on session-identifying information (such as a rendezvous URL for the server and user ID) to a peripheral device to be included into the session. The multimodal browser would conveniently also be provided at the server. However, this is not essential as the browser, wherever located, could refer to the session manager for participant communication data. Another alternative is to provide the server with limited capability to understand the media types of the content being served and to send the correct content types to the appropriate participant as indicated by the session manager with the user still interfacing via their normal browser system and each participant device being responsible for interpretation of its received content from the server.

The session manager 71 could, in fact, be located anywhere in the infrastructure, separate from the browser service system with the latter referring to the session manager for communications information.

The browser functionality can, as already indicated in the introduction to the present specification, be located not only in the communications infrastructure but also at the server or in the user device. Again as already indicated, the present invention is not limited to the use of mark-up based content pages and an interpreting browser, and any appropriate user interfacing handler can be used for interpreting and managing the content provided by the server.

Although the inclusion of devices with the capability of handling additional modalities is clearly advantageous, the present invention is also useful for including additional devices handling the same modalities as the user's device. One example of where this is useful is in the case where the included device has better capabilities for handling the common modalities (for example, the inclusion of a higher resolution display to supplement a small screen display on a mobile phone being used by the user). Another example is the inclusion into a user's current session of communication devices of other users.

The user is preferably enabled to limit the involvement of other devices by authorising each only to receive a specific type of media or specific items or in any other appropriate manner. Furthermore, the user can advantageously dismiss other devices from the session at any time. To this end, a naming scheme is preferably adopted that is understood by the browser and apparent to the user; for example, joining devices could be named by number according to their order of joining with the browser announcing the name of each device as it joins. An alternative naming plan would be to name by functionality (eg “printer” if the device is a printer) with a joining-order number for that functionality being added if more than one device with the same functionality is joined. Rather than the browser naming the devices, the user could be asked to name each device as it joins. Having the devices named is, of course, useful for more than just dismissing the devices—indeed, the devices could themselves be talked to by the user through the browser and instructed accordingly. This can be achieved by having the browser recognise when a user input is intended for another device rather than for return to the content server, the browser, then being responsible for understanding the semantics of the user input and converting it into a form suitable for the named device before outputting it to the latter.

Whilst having each device register their capabilities with the session manager is preferred, this is not essential in that every joined device could be sent all content output from the content server, whatever its form—it is then up to each device to decide whether they can handle the received content.

1. A method of enhancing communication between a user using a first device and a content server with which the user is interacting through an interfacing handler, wherein:
the communication is managed as a session having one or more participants with the user, via the first device, being an initial participant to the session;
the user, using the first device, passes on session joining information to at least one second device;
the at least one second device uses the joining information to join the session; and
the interfacing handler sends content and/or content references from the content server to the participants in the session.

2. A method according to claim 1, wherein the devices register their communication capabilities with the session and the interfacing handler sends content and/or content references from the content server to the devices taking account of their registered capabilities.

3. A method according to claim 1 or claim 2, wherein the interfacing handler sends content from the content server to the at least one second device according to authorisation information specified by the user.

4. A method according to any one of the preceding claims, wherein the content server provides content in multiple media types and the at least one second is capable of handling one or more media types not handled by the first device.

5. A method according to any one of the preceding claims, wherein the interfacing handler is a browser arranged to interpret pages with markup tags provided by the content server.

6. A method according to claim 5, wherein the first device is a voice communication device and the interfacing handler is a multimodal browser capable of handling voice markup pages provided by the content server.

7. A method according to claim 6, wherein the first device is a cellular phone.

8. A method according to any one of the preceding claims, wherein the first device passes on the joining information using a short-range communication link.

9. A method according to any one of the preceding claims, wherein the or each second device is named upon joining the session with a name that is known to both the user and the interfacing handler.

10. A method according to any one of the preceding claims, wherein the user can communicate with at least one second device via the first device and the interfacing handler.

11. A user communication device comprising:
means for setting up a communications session with an interfacing handler through which the user device can receive content from a content server;
means for assembling session joining data for enabling a further device to join the communication session by that device passing the session joining data to the interfacing handler; and
means for sending the session joining information to a said further device independently of the interfacing handler.

12. A device according to claim 11, wherein said means for sending the session joining information is a short-range communication subsystem.

13. A device according to claim 11, wherein said means for assembling session joining data comprises means for receiving a session identifier from the interfacing handler.

14. A peripheral device comprising:
peripheral functionality;
a short-range communications subsystem for receiving session joining data over a short-range communications link; and
a communications subsystem for sending the session joining information to an interfacing handler to join an existing communication session and to receive content for output via the peripheral functionality of the device.

15. A peripheral device according to claim 14, wherein the communications subsystem is operative to send along with said session joining information, data on the types of content that the peripheral device can handle.

16. A voice browser service system for providing voice-form content to a user device, the service system comprising:
a session manager operative to set up a communication session with the user device as an initial member, and to pass the user device a session identifier for the session;
means for retrieving content from a content server and delivering at least some of that content as voice signals to the user device;
receiving means for receiving, from a further device, a joining request including said session identifier and capability information concerning what types of content the further device can handle, the receiving means being operative to pass the request to the session manager, and the session manager being responsive to the request to join the said further device to the communication session and register its capability information; and
means for sending to said further device, whilst joined to the communication session, elements of the said content retrieved from the content server that are of a type which, according to the device's registered capability information, the further device can handle.
